(19) United States
(12) Patent Application Publication
(10) Pub. No.: US 2023/0376560 A1
(43) Pub. Date: Nov. 23, 2023

(54) INFORMATION PROCESSING DEVICE, INFORMATION PROCESSING METHOD, INFORMATION PROCESSING SYSTEM, AND STORAGE MEDIUM

(71) Applicant: NEC Corporation, Minato-ku Tokyo (JP)

(72) Inventor: Kei TAKEMURA, Tokyo (JP)

(21) Appl. No.: 18/030,838

(22) PCT Filed: Oct. 14, 2020
(86) PCT No.: PCT/JP2020/038769

§ 371 Date: Apr. 7, 2023

(51) Int. Cl. G06F 17/11

(52) U.S. Cl. CPC G06F 17/11

(57) ABSTRACT

In order to further increase accumulation of observation values when selecting an option from a plurality of options for which probability distribution is unknown, an information processing apparatus (1) includes an acquisition unit (11), a determination unit (12), and an accumulation unit (13). The acquisition unit (11) acquires pieces of relevant information respectively associated with a plurality of options. The determination unit (12) determines an option to be selected from among the options. The accumulation unit (13) accumulates an observation value of a gain obtained from the determined option and relevant information of the option in a storage apparatus as training data. The determination unit (12) determines, with use of any of a plurality of predictors, an option to be selected from among the options. The plurality of predictors independently learn a relation between the relevant information and the observation value with reference to the training data.

### TECHNICAL FIELD

The present invention relates to a technique to select any of a plurality of options for which a probability distribution of gains is unknown.

### BACKGROUND ART

A bandit algorithm is known as a technique to select any of a plurality of options for which a probability distribution of gains is unknown. The bandit algorithm repeats a trial of selecting any of a plurality of options to observe a gain. In each of the trials, the bandit algorithm determines an option to be selected by referring to observation values of gains obtained in previous trials. The bandit algorithm maximizes accumulation of observation values that are obtained by a certain number of trials, and identifies an option with which an expectation value of gain is maximized.

For example, Non-patent Literature 1 discloses a bandit algorithm with context which is applicable when there is a relation between an observation value of a gain and information (context) associated with the option. The algorithm disclosed in Non-patent Literature 1 learns, in each of trials, a relation between an observation value and a context using, as training data, observation values and contexts which have been obtained in previous trials. The algorithm also predicts a gain of each option using the learned relation to determine an option to be selected.

### CITATION LIST

### Non-Patent Literature

[Non-Patent Literature 1]
Y. Abbasi-Yadkori et. al. “Improved Algorithms for Linear Stochastic Bandits”, In Advances in Neural Information Processing Systems 24, pages 2312-2320, 2011.

### SUMMARY OF INVENTION

### Technical Problem

The algorithm disclosed in Non-patent Literature 1 has room for improvement in terms of an increase in accumulation of observation values. This is because, in each of the trials, if a learned relation between an observation value and a context deviates from an original relation thereof, an option different from an optimal option can be selected.

An example aspect of the present invention is attained in view of the problem. That is, an example object of an example aspect of the present invention is to provide a technique to further increase accumulation of observation values when any of a plurality of options for which a probability distribution is unknown is selected.

### Solution to Problem

An information processing apparatus according to an example aspect of the present invention includes: an acquisition means that acquires pieces of relevant information which are respectively associated with a plurality of options; a determination means that determines an option to be selected from among the plurality of options; and an accumulation means that accumulates, as training data, an observation value of a gain which has been obtained when the option determined by the determination means had been selected and relevant information of the option in a storage apparatus. The determination means determines, with use of any of a plurality of predictors, an option to be selected from among the plurality of options. The plurality of predictors independently learn a relation between the relevant information and the observation value with reference to the training data.

An information processing method according to an example aspect of the present invention includes: acquiring, by an information processing apparatus, pieces of relevant information which are respectively associated with a plurality of options; determining, by the information processing apparatus, an option to be selected from among the plurality of options; and accumulating, by the information processing apparatus, an observation value of a gain which has been obtained when the option determined had been selected and relevant information of the option in a storage apparatus as training data. The information processing method also includes using, by the information processing apparatus, any of a plurality of predictors in order to determine an option to be selected from among the plurality of options. The plurality of predictors independently learn a relation between the relevant information and the observation value with reference to the training data.

A storage medium according to an example aspect of the present invention stores a program that causes a computer to function as an information processing apparatus. The program causes the computer to function as: an acquisition means that acquires pieces of relevant information which are respectively associated with a plurality of options; a determination means that determines an option to be selected from among the plurality of options; and an accumulation means that accumulates, as training data, an observation value of a gain which has been obtained when the option determined by the determination means had been selected and relevant information of the option in a storage apparatus. The determination means determines, with use of any of a plurality of predictors, an option to be selected from among the plurality of options. The plurality of predictors independently learn a relation between the relevant information and the observation value with reference to the training data.

An information processing system according to an example aspect of the present invention includes an information processing apparatus and a server. The information processing apparatus includes: an acquisition means that receives, from the server, pieces of relevant information which are respectively associated with a plurality of options; a determination means that determines an option to be selected from among the plurality of options and that transmits, to the server, information indicating the option which has been determined; and an accumulation means that receives, from the server, an observation value of a gain which has been obtained when the option determined by the determination means had been selected, and that accumulates, as training data, the observation value which has been received and relevant information of the option in a storage apparatus. The determination means determines, with use of any of a plurality of predictors, an option to be selected from among the plurality of options. The plurality of predictors independently learn a relation between the relevant information and the observation value with reference to the training data. The server includes: an acquisition means that acquires the relevant information and transmits the relevant information to the information processing apparatus; a selection means that selects an option which is indicated by information received from the information processing apparatus; and an observation means that observes a gain which is obtained by selection by the selection means, and that transmits an observation value which has been observed to the information processing apparatus.

An information processing method according to an example aspect of the present invention includes: receiving, by an information processing apparatus, pieces of relevant information which are respectively associated with a plurality of options from a server; determining, by the information processing apparatus, an option to be selected from among the plurality of options and transmitting, by the information processing apparatus, information indicating the option which has been determined to the server; and receiving, by the information processing apparatus, an observation value of a gain which has been obtained when the option determined had been selected from the server, and accumulating, by the information processing apparatus, the observation value which has been received and relevant information of the option in a storage apparatus as training data. The information processing method includes using, by the information processing apparatus, any of a plurality of predictors in order to determine an option to be selected from among the plurality of options. The plurality of predictors independently learn a relation between the relevant information and the observation value with reference to the training data. The information processing method includes: acquiring, by the server, the relevant information and transmitting, by the server, the relevant information to the information processing apparatus; selecting, by the server, an option which is indicated by information received from the information processing apparatus; and observing, by the server, a gain which is obtained by selection of the option, and transmitting, by the server, an observation value which has been observed to the information processing apparatus.

### Advantageous Effects of Invention

According to an example aspect of the present invention, it is possible to further increase accumulation of observation values.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of an information processing method which is carried out by the information processing apparatus according to the first example embodiment of the present invention.

FIG. 3 is a block diagram illustrating a configuration of an information processing system according to a second example embodiment of the present invention.

FIG. 4 is a flowchart illustrating a flow of an information processing method which is carried out by the information processing system according to the second example embodiment of the present invention.

FIG. 5 is a block diagram illustrating a configuration of an information processing apparatus according to a third example embodiment of the present invention.

FIG. 6 is a diagram schematically illustrating an information processing method which is carried out by the information processing apparatus according to the third example embodiment of the present invention.

FIG. 7 is a flowchart schematically illustrating a flow of an information processing method which is carried out by the information processing apparatus according to the third example embodiment of the present invention.

FIG. 8 is a flowchart illustrating in detail a flow of a part of the information processing method which is carried out by the information processing apparatus according to the third example embodiment of the present invention.

FIG. 9 is a block diagram illustrating a configuration of an information processing system according to a fourth example embodiment of the present invention.

FIG. 10 is a flowchart schematically illustrating a flow of an information processing method which is carried out by the information processing system according to the fourth example embodiment of the present invention.

FIG. 11 is a flowchart illustrating in detail a flow of a part of the information processing method which is carried out by the information processing system according to the fourth example embodiment of the present invention.

FIG. 12 is a graph illustrating an Example using the information processing apparatus according to the fourth example embodiment of the present invention.

FIG. 13 is a block diagram illustrating an example of a hardware configuration of the information processing apparatus according to each of the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

<Overview of Information Processing Apparatus>

An information processing apparatus 1 repeats a trial of: acquiring pieces of relevant information which are respectively associated with a plurality of options; determining an option to be selected from among the plurality of options; and accumulating, as training data, an observation value which has been obtained when the option determined had been selected and relevant information.

<Configuration of Information Processing Apparatus>

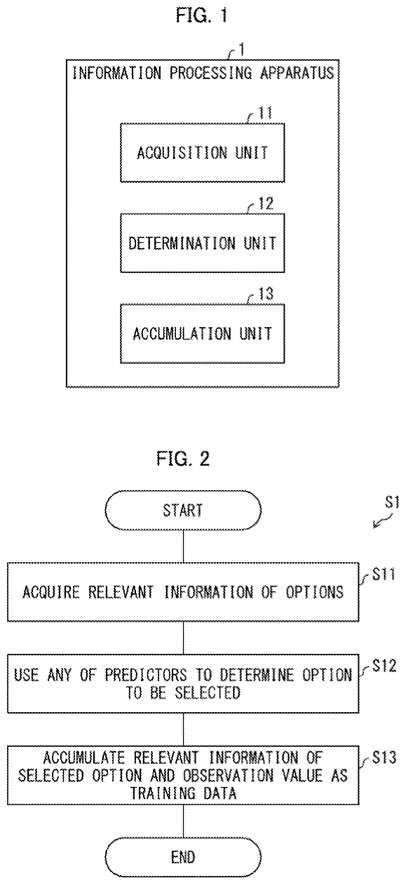

The following description will discuss a configuration of the information processing apparatus 1 according to the present example embodiment with reference to FIG. 1. FIG. 1 is a block diagram illustrating the configuration of the information processing apparatus 1.

As illustrated in FIG. 1, the information processing apparatus 1 includes an acquisition unit 11, a determination unit 12, and an accumulation unit 13. The acquisition unit 11 is configured to realize the acquisition means in the present example embodiment. The determination unit 12 is configured to realize the determination means in the present example embodiment. The accumulation unit 13 is configured to realize the accumulation means in the present example embodiment.

The acquisition unit 11 acquires pieces of relevant information which are respectively associated with a plurality of options. Hereinafter, relevant information associated with an option is also simply referred to as “relevant information of an option”. For example, the acquisition unit 11 may acquire pieces of relevant information of options via an input apparatus (not illustrated). For example, the acquisition unit 11 may acquire pieces of relevant information of options from another apparatus (not illustrated) that is communicably connected with the information processing apparatus 1.

The determination unit 12 determines an option to be selected from among the plurality of options. Specifically, the determination unit 12 determines, with use of any of a plurality of predictors, an option to be selected from among the plurality of options. Here, each of the plurality of predictors learns a relation between relevant information and an observation value of a gain with reference to training data stored in a storage apparatus. A gain is a quantitative representation of effectiveness gained by selecting an option. An observation value is a gain observed when an option is actually selected. Moreover, the predictors learn the relation independently of each other. Here, “learning independently of each other” may mean, for example, that training data sets which are used by the predictors for learning differ from each other.

The accumulation unit 13 acquires an observation value of a gain which has been obtained when the option determined by the determination unit 12 had been selected. Moreover, the accumulation unit 13 accumulates the observation value which has been acquired and relevant information of the option in a storage apparatus (not illustrated) as training data. The storage apparatus can be included in the information processing apparatus 1 or can be communicably connected with the information processing apparatus 1.

<Flow of Information Processing Method>

The following description will discuss a flow of an information processing method S1 that is carried out by the information processing apparatus 1 configured as described above, with reference to FIG. 2. FIG. 2 is a flowchart illustrating the flow of the information processing method S1. The information processing apparatus 1 carries out the information processing method S1 in each of trials of determining an option to be selected from among the plurality of options.

As illustrated in FIG. 2, the information processing method S1 includes steps S11 through S13.

(Step S11)

In step S11, the acquisition unit 11 acquires pieces of relevant information of the respective plurality of options.

(Step S12)

In step S12, the determination unit 12 determines, with use of any of a plurality of predictors, an option to be selected from among the plurality of options.

(Step S13)

In step S13, the accumulation unit 13 acquires an observation value of a gain which has been obtained when the option determined by the determination unit 12 had been selected. Moreover, the accumulation unit 13 accumulates the observation value which has been acquired and relevant information of the option in a storage apparatus as training data.

<Effect of the Present Example Embodiment>

As described above, in the present example embodiment, a configuration is employed in which any of the plurality of predictors is used to determine an option to be selected from among the plurality of options. The plurality of predictors learn the relation between relevant information and observation values independently of each other with reference to training data. Therefore, it is possible to use, in order to determine an option to be selected from among a plurality of options, a predictor which has more appropriately learned a relation between an observation value and relevant information. As a result, the present example embodiment makes it possible to determine an option that further increases accumulation of gains.

### Second Example Embodiment

The following description will discuss a second example embodiment of the present invention in detail with reference to the drawings.

<Overview of Information Processing System>

An information processing system 10A according to the present example embodiment is a system in which an information processing apparatus 1A, which is a variation of the first example embodiment, functions in cooperation with a server 3A.

<Configuration of Information Processing System>

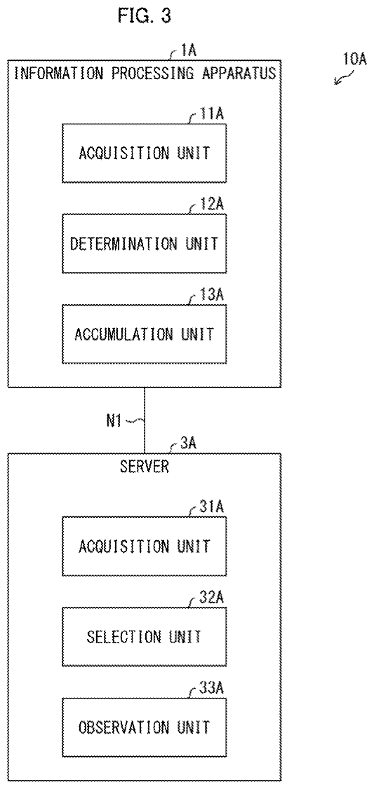

The following description will discuss a configuration of the information processing system 10A with reference to FIG. 3. FIG. 3 is a block diagram illustrating the configuration of the information processing system 10A. As illustrated in FIG. 3, the information processing system 10A includes an information processing apparatus 1A and a server 3A. The information processing apparatus 1A and the server 3A are communicably connected to each other via a network N1. The network N1 is a wireless local area network (LAN), a wired LAN, a wide area network (WAN), a public network, a mobile data communication network, or a combination of these networks.

(Configuration of Information Processing Apparatus 1A)

As illustrated in FIG. 3, the information processing apparatus 1A includes an acquisition unit 11A, a determination unit 12A, and an accumulation unit 13A.

The acquisition unit 11A is configured in a manner substantially identical with that of the acquisition unit 11 according to the first example embodiment, except that the acquisition unit 11A receives relevant information from the server 3A. The other configurations are similar to those of the acquisition unit 11.

The determination unit 12A is configured in a manner substantially identical with that of the determination unit 12 in the first example embodiment, except that the determination unit 12A receives information indicating an option determined to the server 3A. The other configurations are similar to those of the determination unit 12.

The accumulation unit 13A is configured in a manner substantially identical with that of the accumulation unit 13 according to the first example embodiment, except that the accumulation unit 13A receives an observation value from the server 3A. The other configurations are similar to those of the accumulation unit 13.

(Configuration of Server 3A)

As illustrated in FIG. 3, the server 3A includes an acquisition unit 31A, a selection unit 32A, and an observation unit 33A.

The acquisition unit 31A acquires pieces of relevant information of the respective plurality of options and transmits the acquired pieces of relevant information to the information processing apparatus 1A. For example, the acquisition unit 31A may acquire pieces of relevant information from a respective plurality of terminals (not illustrated) that are communicably connected with the server 3A.

The selection unit 32A selects an option which is indicated by information received from the information processing apparatus 1A. For example, the selection unit 32A may transmit information indicating that the option has been selected to a terminal from which relevant information of the option had been acquired.

The observation unit 33A observes a gain which is obtained by selection by the selection unit 32A and transmits an observation value which has been observed to the information processing apparatus 1A. For example, the observation unit 33A receives information from a terminal to which the selection unit 32A has transmitted the information, and acquires, as an observation value, a result of observing the received information.

<Flow of Information Processing Method>

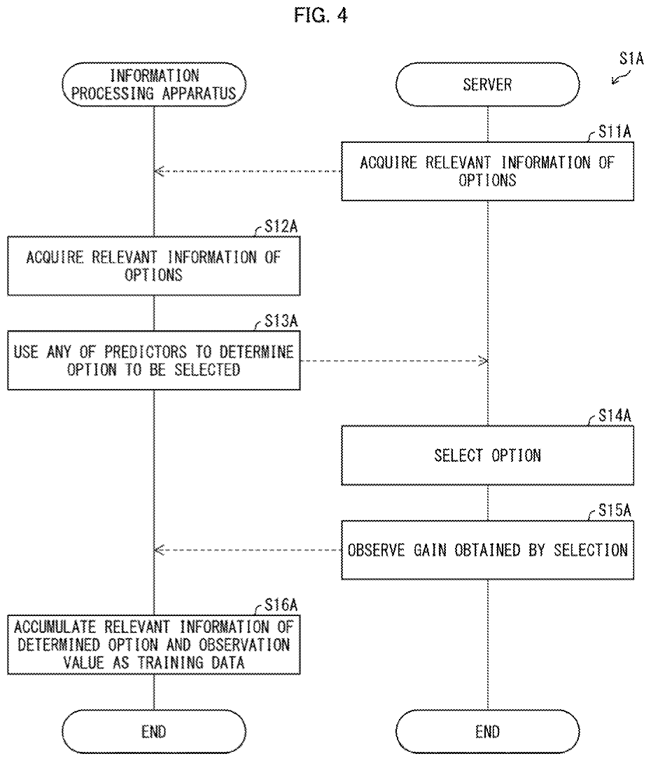

The following description will discuss a flow of an information processing method S1A that is carried out by the information processing system 10A configured as described above, with reference to FIG. 4. FIG. 4 is a flowchart illustrating the flow of the information processing method S1A. The information processing system 10A carries out the information processing method S1A in each of trials of determining an option to be selected from among a plurality of options.

As illustrated in FIG. 4, the information processing method S1A includes steps S11A through S16A.

(Step S11A)

In step S11A, the acquisition unit 31A of the server 3A acquires pieces of relevant information of a respective plurality of options. Moreover, the acquisition unit 31A transmits the pieces of relevant information which have been acquired to the information processing apparatus 1A.

(Step S12A)

In step S12A, the acquisition unit 11A of the information processing apparatus 1A receives pieces of relevant information of options from the server 3A.

(Step S13A)

In step S13A, the determination unit 12A determines, with use of any of a plurality of predictors, an option to be selected from among the plurality of options. Details of the determination process are the same as those described in step S12 in the first example embodiment. Moreover, the determination unit 12A transmits information indicating the determined option to the server 3A.

(Step S14A)

In step S14A, the selection unit 32A of the server 3A selects the option which is indicated by the information received from the information processing apparatus 1A.

(Step S15A)

In step S15A, the observation unit 33A observes a gain which is obtained by selection by the selection unit 32A, and transmits the observation value which has been observed to the information processing apparatus 1A.

(Step S16A)

In step S16A, the accumulation unit 13A of the information processing apparatus 1A accumulates the observation value which has been received and relevant information of the option determined in step S13A in a storage apparatus as training data.

<Effect of the Present Example Embodiment>

With the above configuration, the present example embodiment achieves an effect similar to that of the first example embodiment by cooperation between the information processing apparatus 1A and the server 3A.

### Third Example Embodiment

The following description will discuss a third example embodiment of the present invention in detail with reference to the drawings. Here, the present example embodiment further solves the following problem in the related technique disclosed in Non-patent Literature 1, in addition to solving the problem described in “Technical Problem” above.

<Problem of Related Technique>

The algorithm disclosed in the foregoing Non-patent Literature 1 assumes a linear model as a relation between an observation value and a context. Therefore, the algorithm has a problem that, if a relation between an observation value and a context cannot be expressed by a linear model, there is a possibility that an option which further increases accumulation of observation values cannot be selected. This is because of the following reason. When the algorithm is used, an option different from an optimal option can be selected in each of trials due to a deviation of a linear model from an original relation between an observation value and a context. As a result, in each of the trials, a loss can occur in a comparison between an observation value and a gain that should be obtained from an optimal option. Therefore, accumulation of losses increases as the number of trials increases.

Moreover, another contextual bandit algorithm disclosed in Reference Literature 1 below has the following problem. That is, the algorithm disclosed in Reference Literature 1 assumes that, in a relation between an observation value and a context, a difference with respect to a linear model can be identified. The algorithm also assumes that a set of options in each of trials does not change. Therefore, the algorithm has a problem that the algorithm cannot be applied to a case where a difference from the linear model cannot be identified or a case where a set of options changes in each of trials.
[Reference Literature 1] Tor Lattimore et. al. “Learning with good feature representations in bandits and in RL with a generative model”, arXiv preprint arXiv:1911.07676, 2019.

An information processing apparatus 1B according to the present example embodiment has a configuration described below in order to solve the problems of the related techniques described above.

<Overview of Information Processing Apparatus>

An information processing apparatus 1B repeats a trial of: acquiring pieces of relevant information which are respectively associated with a plurality of options; determining an option to be selected from among the plurality of options; and accumulating, as training data, an observation value which has been obtained when the option determined had been selected and relevant information. In each of the trials, the information processing apparatus 1B sequentially carries out, from the first predictor of a plurality of predictors, a process using each of the plurality of predictors until a predictor suitable for determination of an option is found. Moreover, the information processing apparatus 1B accumulates training data including an observation value of a gain which has been obtained when the option determined had been selected, in association with a predictor which has been used for determination of the option.

<Configuration of Information Processing Apparatus 1B>

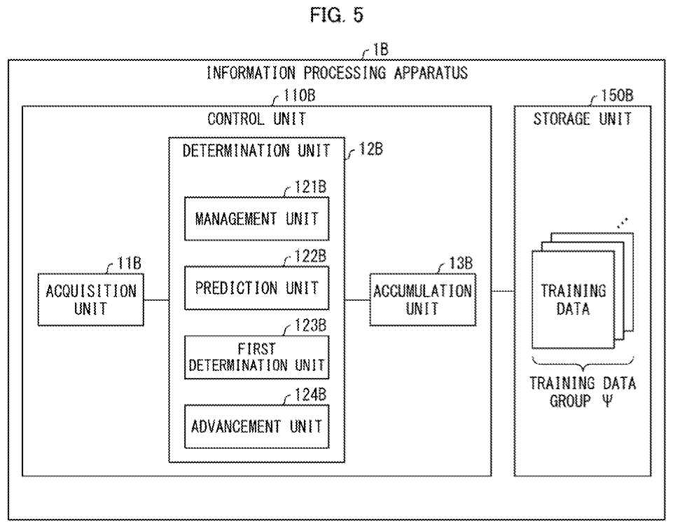

The following description will discuss a configuration of the information processing apparatus 1B according to the present example embodiment with reference to FIG. 5. FIG. 5 is a block diagram illustrating the configuration of the information processing apparatus 1B.

As illustrated in FIG. 5, the information processing apparatus 1B includes a control unit 110B and a storage unit 150B. The control unit 110B includes an acquisition unit 11B, a determination unit 12B, and an accumulation unit 13B. The storage unit 150B stores a training data group Ψ that includes one or more pieces of training data.

The acquisition unit 11B is configured to realize the acquisition means in the present example embodiment. The determination unit 12B is configured to realize the determination means in the present example embodiment. The accumulation unit 13B is configured to realize the accumulation means in the present example embodiment. The storage unit 150B is configured to realize the storage apparatus in the present example embodiment.

The acquisition unit 11B acquires pieces of relevant information for the respective plurality of options. A set of a plurality of options for which pieces of relevant information are acquired can be variable in each of trials. That is, in each of the trials, the number of options of interest can be different from the number of options of interest in another trial. Moreover, in each of the trials, at least one option of interest can be different from options in another trial.

The determination unit 12B determines, with use of any of a plurality of predictors, an option to be selected from among a plurality of options. Details of the determination unit 12B will be described later.

The accumulation unit 13B acquires an observation value of a gain which has been obtained when the option determined by the determination unit 12B had been selected. Moreover, the accumulation unit 13B accumulates training data including the observation value which has been acquired and the option which has been determined by the determination unit 12B in the storage unit 150B in association with a predictor which has been used for determination of the option.

(Detailed Configuration of Determination Unit)

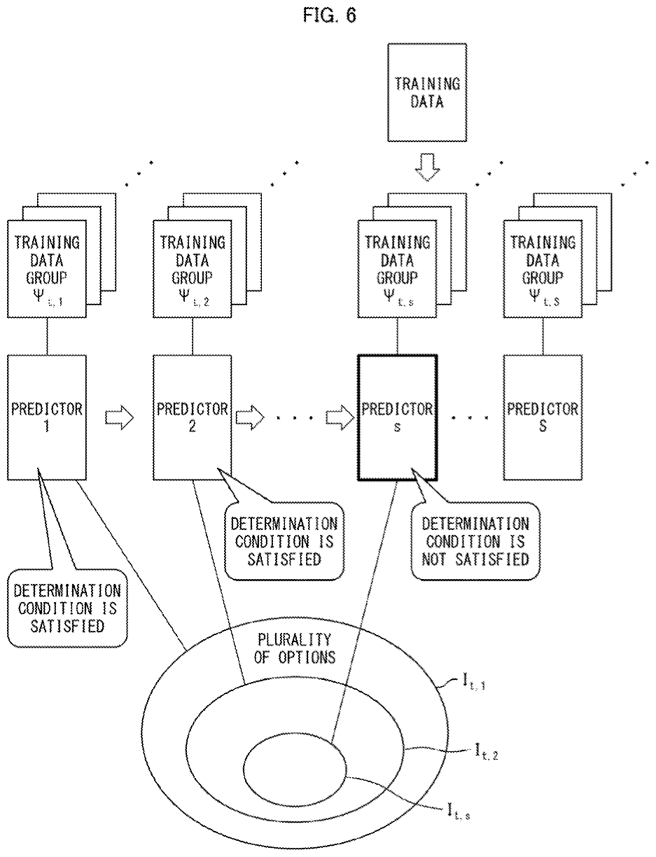

The following description will discuss a detailed configuration of the determination unit 12B with reference to FIGS. 5 and 6. FIG. 5 is a block diagram illustrating the configuration of the information processing apparatus 1B as described above. FIG. 6 is a diagram schematically illustrating an information processing method which is carried out by the information processing apparatus 1B. As illustrated in FIG. 5, the determination unit 12B includes a management unit 121B, a prediction unit 122B, a first determination unit 123B, and an advancement unit 124B.

The management unit 121B manages S pieces of predictors. Here, S is an integer of 2 or more. The management unit 121B generates and initializes S pieces of predictors. Initialization means to generate initial functions which are predetermined as a prediction function and a prediction error function which will be described later. The management unit 121B sequentially uses the predictors in each of the trials to carry out a prediction process. In a case where a determination condition is satisfied, the management unit 121B carries out an advancement process. In a case where the determination condition is not satisfied, the management unit 121B carries out a first determination process. In a case where the first determination process has been carried out using any of the predictors, the management unit 121B does not carry out processes using the other predictors in that trial. Details of the prediction process, the first determination process, and the advancement process will be described later.

Here, as illustrated in FIG. 6, the order in which the S pieces of predictors are used by the management unit 121B is determined. In the example of FIG. 6, the order is determined as follows: a predictor 1, a predictor 2, . . . and a predictor S. In other words, in this example, the reference signs “s” (s=1, 2, . . . , S) given to the predictors represent an order determined for the predictors. A predictor that is currently used by the management unit 121B is referred to also as a current predictor. An action of the management unit 121B to terminate a process using the current predictor and to start a process using a next predictor is expressed also as “advancing a process to a next predictor” or “a process proceeds to a next predictor”. That is, the management unit 121B carries out the foregoing process using the current predictor in order of the predictor 1, the predictor 2, and so forth, and advances the process to the next predictor until the first determination process is carried out.

(Configuration of Prediction Unit)

The prediction unit 122B carries out the prediction process. The prediction process is a process of predicting, with use of a current predictor, a prediction error involved in a prediction value for each of options in an option group dealt with by the current predictor. Specifically, the prediction process includes: a learning process of causing the current predictor to learn a relation between an observation value and relevant information; and a calculation process of calculating a prediction value and a prediction error using the relation.

(Option Group of Interest)

Here, an option group of interest is one or more options among a plurality of options. As illustrated in FIG. 6, a predictor s deals with an option group I_{t,s} in a trial t (t=1, 2, . . . , T). An option group I_{t,1} to be dealt with by the predictor 1 includes options respectively associated with pieces of relevant information which have been acquired by the acquisition unit 11B. An option group I_{t,2} to be dealt with by the predictor 2 is one or more options extracted from the option group I_{t,1}. Thus, an option group to be dealt with by a next predictor is extracted from an option group dealt with by the current predictor. Extraction of an option group is carried out by the advancement unit 124B which will be described later.

(Learning Process)

The learning process is a process of causing the current predictor to learn a relation between an observation value and relevant information. The relation can be, for example, a linear relation. For learning by the current predictor, one or more pieces of training data associated with the predictor are used among the training data group T stored in the storage unit 150B. One piece of training data includes relevant information of an option and an observation value of a gain obtained when the option is selected. For example, as illustrated in FIG. 6, a training data group Ψ_{t,s} is associated with the predictor s. The training data group Ψ_{t,s} is included in the training data group Ψ stored in the storage unit 150B. The training data group Ψ_{t,s} includes pieces of training data which have been associated with the predictor s by a trial t−1. A process of associating training data with the predictor s is carried out by the accumulation unit 13B.

Here, learning by the predictor s is machine learning using the training data group Ψ_{t,s}. The prediction unit 122B constructs a prediction function and a prediction error function by machine learning by the predictor s. The prediction function is a function for predicting an observation value of a gain based on relevant information. The prediction error function is a function for calculating a prediction error which is involved in a prediction value obtained by the prediction function. Hereinafter, the prediction function and the prediction error function constructed by machine learning by the predictor s are also simply referred to as a prediction function and a prediction error function constructed by the predictor s.

(Calculation Process)

The calculation process is a process of calculating a prediction value and a prediction error by applying a prediction function and a prediction error function which have been constructed by the current predictor to pieces of relevant information of respective options in an option group dealt with by the current predictor.

(Configuration of First Determination Unit)

The first determination unit 123B carries out the first determination process. The first determination process is a process of determining, in a case where a determination condition is not satisfied, an option to be selected from among options in an option group dealt with by the current predictor.

(Determination Condition)

Here, the determination condition is a condition pertaining to each prediction error which has been predicted in the prediction process. In the present example embodiment, a condition in which each of prediction errors is equal to or lower than a first threshold is used as the determination condition. Note that, in the present example embodiment, the first threshold is an example of the “threshold” recited in the claims. That is, a case in which the determination condition is not satisfied indicates that at least any of the prediction errors is greater than the first threshold.

(Configuration of Advancement Unit)

The advancement unit 124B carries out the advancement process. The advancement process is a process in which, in a case where the determination condition is satisfied, an option group to be dealt with by the next predictor is extracted from an option group dealt with by the current predictor, and the process proceeds to the next predictor. Specifically, the advancement unit 124B extracts, from the option group dealt with by the current predictor, an option(s) satisfying a condition of being more likely to be an optimal option as an option group to be dealt with by the next predictor. For example, the advancement unit 124B extracts, from the option group dealt with by the current predictor, one or more options for which a sum of a prediction value and a prediction error is equal to or greater than a predetermined value as an option group to be dealt with by the next predictor. Subsequently, the management unit 121B advances the process to the next predictor. That is, the management unit 121B carries out the prediction process using the next predictor and carries out, using the next predictor, the first determination process or the advancement process.

(Specific Example of Advancement Process Using Predictor)

The following description will discuss a specific example of a process that proceeds in order from the predictor 1, with reference to FIG. 6. In the example of FIG. 6, the process proceeds in order from the predictor 1, and the first determination process is carried out using the predictor s. In this case, an option to be selected is determined with use of the predictor s. Specifically, a prediction process is carried out using the predictor 1, and the determination condition is satisfied. Therefore, the process proceeds to the predictor 2. Next, a prediction process is carried out using the predictor 2, and the determination condition is satisfied. Therefore, the process proceeds to the next predictor. Then, the process sequentially proceeds to next predictors, and a prediction process is carried out using the predictor s, and the determination condition is not satisfied. Therefore, any option in the option group I_{t,s} dealt with by the predictor s is determined as an option to be selected. For example, an option having a prediction error greater than the first threshold is determined from among the option group I_{t,s}. Moreover, training data including an observation value obtained when the option has been selected is added to the training data group Ψ_{t,s}.

<Flow of Information Processing Method>

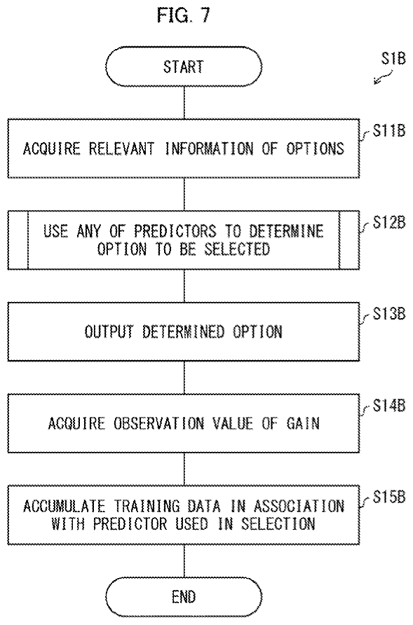

The following description will discuss a flow of an information processing method S1B that is carried out by the information processing apparatus 1B configured as described above, with reference to FIG. 7. FIG. 7 is a flowchart illustrating the flow of the information processing method S1B. The information processing apparatus 1B carries out the information processing method S1B in each of trials of determining an option to be selected from among the plurality of options.

As illustrated in FIG. 7, the information processing method S1B includes steps S11B through S15B.

(Step S11B)

In step S11B, the acquisition unit 11B acquires pieces of relevant information for the respective plurality of options.

(Step S12B)

In step S12B, the determination unit 12B determines, with use of any of a plurality of predictors, an option to be selected. Details of this step will be described later.

(Step S13B)

In step S13B, the determination unit 12B outputs information indicating the option which has been determined. For example, the determination unit 12B may cause a display apparatus or the like to display information indicating the option which has been determined.

(Step S14B)

In step S14B, the accumulation unit 13B acquires an observation value of a gain which has been obtained when the option determined had been selected. For example, the accumulation unit 13B may acquire the observation value via an input apparatus.

(Step S15B)

In step S15B, the accumulation unit 13B accumulates training data including the observation value and relevant information of the option which has been determined in the storage unit 150B in association with a predictor which has been used in determination of the option in step S12B.

Then, the information processing apparatus 1B ends the information processing method S10.

<Detailed Flow of Determination Process>

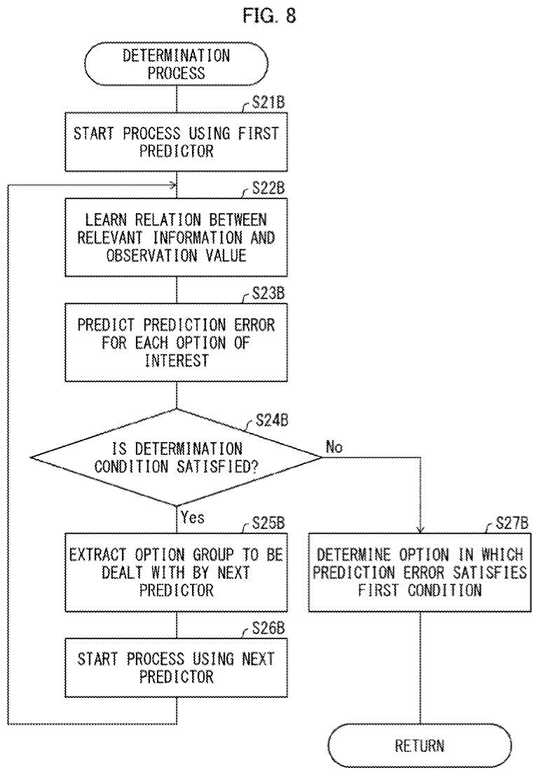

Next, the following description will discuss a detailed flow of the process in step S12B with reference to FIG. 8. FIG. 8 is a flowchart illustrating in detail a flow of a process of determining an option to be selected. As illustrated in FIG. 8, the step S12B includes steps S21B through S27B.

(Step S21B)

In step S21B, the management unit 121B starts a process using a first predictor.

(Step S22B)

In step S22B, the prediction unit 122B causes the current predictor to learn a relation between an observation value and relevant information. Specifically, the prediction unit 122B constructs a prediction function and a prediction error function using the current predictor.

(Step S23B)

In step S23B, the prediction unit 122B predicts, with use of the current predictor, a prediction error which is involved in a prediction value of a gain for each of options in an option group dealt with by the current predictor. Specifically, the prediction unit 122B calculates a prediction value and a prediction error by applying the prediction function and the prediction error function constructed in step S22B to each of pieces of relevant information of the respective options.

(Step S24B)

In step S24B, the management unit 121B determines whether or not a determination condition pertaining to the prediction errors predicted in step S23B is satisfied. Here, a condition in which each of prediction errors is equal to or lower than a first threshold is applied as the determination condition.

(Yes in step S24B: Step S25B)

If it is determined to be Yes in step S24B, in step S25B, the advancement unit 124B extracts, from the option group dealt with by the current predictor, one or more options as an option group to be dealt with by the next predictor. For example, the advancement unit 124B extracts an option for which a sum of the prediction value and the prediction error predicted in step S23B is greater than a predetermined value.

(Step S26B)

In step S26B, the management unit 121B starts a process using the next predictor and repeats the process from step S22B.

(No in step S24B: Step S27B)

Meanwhile, if it is determined to be No in step S24B, the first determination unit 123B determines, in step S27B, an option to be selected from among the option group dealt with by the current predictor. In this case, the first determination unit 123B determines that an option is selected in which a prediction error is equal to or greater than the first threshold. Then, the information processing apparatus 1B ends the determination process in step S12B.

<Effect of the Present Example Embodiment>

As described above, the information processing apparatus 1B and the information processing method S1B according to the present example embodiment employ the following configurations (i) through (iii). Configuration (i) is configured to predict, with use of a current predictor, a prediction error involved in a prediction value of a gain for each of options in an option group dealt with by that predictor. Configuration (ii) is configured to determine, in a case where a determination condition pertaining to each of prediction errors is not satisfied, an option to be selected from among options in an option group dealt with by that predictor. Configuration (iii) is a configuration in which, in a case where the determination condition is satisfied, one or more options from an option group of interest are extracted as an option group to be dealt with by another predictor, and the prediction error of each of the options is predicted using the another predictor. In the present example embodiment, a condition in which each of prediction errors is equal to or lower than a first threshold is employed as the determination condition.

The present example embodiment further employs the following configurations (iv) and (v). Configuration (iv) is configured to accumulate training data including an observation value which has been obtained when an option determined had been selected and relevant information of the option in a storage unit in association with a predictor used for determination of the option. Configuration (v) is a configuration in which each of a plurality of predictors learns a relation between an observation value and relevant information with reference to training data associated with that predictor from among pieces of training data accumulated in the storage unit.

In the present example embodiment having these configurations, options are narrowed down with use of a predictor having a smaller prediction error, and then an option to be selected is determined with use of another predictor that should be caused to learn more because at least any of prediction errors thereof is large. Thus, the present example embodiment can select an option having a smaller prediction error.

The present example embodiment uses, as training data for further learning by a predictor used in determination of an option, an observation value obtained when an option having a large prediction error has been selected. Therefore, it is possible to more effectively cause a predictor that has insufficient prediction accuracy to learn.

### Fourth Example Embodiment

The following description will discuss a fourth example embodiment of the present invention in detail with reference to the drawings.

<Overview of Information Processing System>

An information processing system 10C according to the present example embodiment is a system in which an information processing apparatus 1C functions in cooperation with a server 3C. The information processing apparatus 1C is a variation of the information processing apparatus 1B according to the third example embodiment. The server 3C is a variation of the server 3A according to the second example embodiment.

In the present example embodiment, a user is applied as an example of an option in the second or third example embodiment. Moreover, as an example of relevant information in the second or third example embodiment, feature information indicating a feature of a user is applied. Moreover, as an example of “selecting an option” in the second or third example embodiment, “sending a promotion of a product to a user” is applied. Moreover, as an example of an observation value in the second or third example embodiment, a sending result of a promotion is applied. Hereinafter, a description such as “similar to that of the second or third example embodiment” means that a matter of interest is similarly described by reading an “option” as a “user”, reading “relevant information” as “feature information”, reading “selection of an option” as “sending of a promotion”, and reading an “observation value” as a “sending result”, in the descriptions of the second or third example embodiment.

Specifically, the information processing system 10C according to the present example embodiment is a system in which any of a plurality of users is selected and a promotion is sent to the user selected. The promotion is, for example, a promotion for selling a product. A type of a promotion is not limited, and the following description assumes that one type of a promotion is used.

The information processing system 10C repeats a trial of: acquiring pieces of feature information indicating respective features of a plurality of users; determining a user to be selected from among the plurality of users; and accumulating a sending result of a promotion to the user determined and feature information as training data. The sending result indicates a product purchasing behavior of a user to whom a promotion has been sent, and indicates, for example, whether or not the user has purchased the product.

<Configuration of Information Processing System>

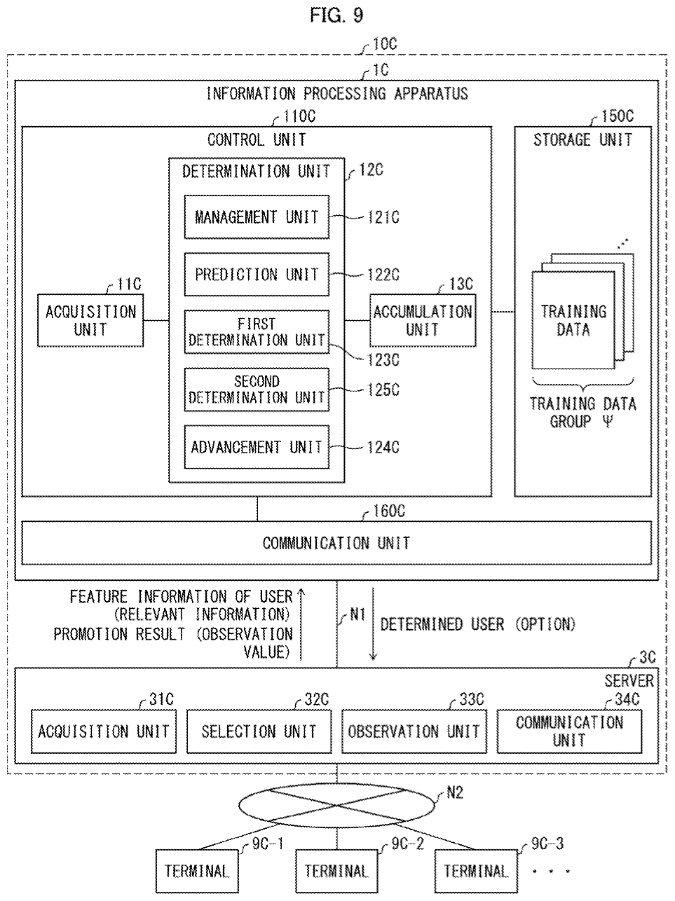

The following description will discuss a configuration of the information processing system 10C with reference to FIG. 9. FIG. 9 is a block diagram illustrating the configuration of the information processing system 10C. As illustrated in FIG. 9, the information processing system 10C includes an information processing apparatus 1C and a server 3C. The information processing apparatus 1C and the server 3C are communicably connected to each other via a network N1. The server 3C is communicably connected with a plurality of terminals 9C-i (i=1, 2, . . . , I: I is an integer of 2 or more) via a network N2. FIG. 9 illustrates three terminals 9C-i. However, the number of terminals 9C-i to which the server 3C is connected can be two or can be four or more. Note that the networks N1 and N2 are each a wireless LAN, a wired LAN, a WAN, a public network, a mobile data communication network, or a combination of these networks.

(Configuration of Server 3C)

The server 3C is an apparatus that transmits information indicating a promotion with respect to any of the plurality of terminals 9C-i in each of trials t (t=1, 2, . . . , T: T is an integer of 2 or more). That is, information transmitted by the server 3C is presented to a user i of a terminal 9C-i. Hereinafter, transmission of information indicating a promotion to a terminal 9C-i is referred to also as sending of a promotion to a user i. The user i exhibits a purchasing behavior with respect to the promotion which has been sent. Here, the purchasing behavior is assumed to be either purchasing or not purchasing a product. Note, however, that the purchasing behavior is not limited to these two types of behaviors. The purchasing behavior can include three or more types of behaviors.

As illustrated in FIG. 9, the server 3C includes an acquisition unit 31C, a selection unit 32C, an observation unit 33C, and a communication unit 34C.

In each of the trials t, the acquisition unit 31C receives, from the terminals 9C-i, pieces of feature information of the respective plurality of users i of interest. Moreover, the acquisition unit 31C transmits the pieces of feature information which have been received to the information processing apparatus 1C. Note that a set of “the plurality of users i of interest (that is, the plurality of terminals 9C-i of interest) in each of the trials t” is variable. That is, in each of the trials t, the number of users i of interest can be different from the number of users of interest in another trial. Moreover, in each of the trials t, at least one user i of interest can be different from users in another trial. The number of users i which are determined by the information processing apparatus 1C in each of the trials is not limited, and is assumed here to be 1.

The selection unit 32C sends a promotion to a user i which is indicated by information received from the information processing apparatus 1C.

The observation unit 33C observes a sending result of the promotion by the selection unit 32C and transmits the result to the information processing apparatus 1C. Observation of the sending result of the promotion is, for example, observation of a purchasing behavior of a user i to whom the promotion has been sent. In this case, the sending result is information indicating whether or not the user i has purchased the product.

The communication unit 34C transmits/receives information to/from the information processing apparatus 1C via the network N1.

(Configuration of Information Processing Apparatus 1C)

As illustrated in FIG. 9, the information processing apparatus 1C includes a control unit 110C, a storage unit 150C, and a communication unit 160C.

The storage unit 150C stores a training data group Ψ. Pieces of training data constituting the training data group Ψ each include feature information of a user and a sending result of a promotion to the user.

The communication unit 160C transmits/receives information to/from the server 3C via the network N1.

The control unit 110C includes an acquisition unit 11C, a determination unit 12C, and an accumulation unit 13C.

Here, the acquisition unit 11C is configured to realize the acquisition means in the present example embodiment. The determination unit 12C is configured to realize the determination means in the present example embodiment. The accumulation unit 13C is configured to realize the accumulation means in the present example embodiment. The storage unit 150C is configured to realize the storage apparatus in the present example embodiment.

The acquisition unit 11C receives, in each of the trials t, pieces of feature information of the respective plurality of users i from the server 3C. As described above, the set of the plurality of users i of interest for whom the pieces of feature information are acquired is variable in each of the trials. The feature information is information indicating a feature of a user i, and has a dimensionality d. Here, the dimensionality of the feature information refers to, for example, the dimensionality of a vector space necessary to represent the feature information as a vector. For example, in a case where feature information is expressed by a plurality of numerical values, the number of the numerical values is a dimension of the feature information. As a specific example, feature information may include four items: identification information of a user i; a record of promotions sent to the user i; a record of products purchased by the user i; and an age of the user i. In this case, the dimensionality of the feature information is 4. Note, however, that this specific example does not limit the configuration and the dimensionality d of feature information.

The determination unit 12C determines, with use of any of S pieces of predictors, a user to be selected from among the plurality of users i. A predictor used in determination of a user i is referred to as a predictor s1. Moreover, the determination unit 12C transmits information indicating the determined user i to the server 3C. Details of the determination unit 12C will be described later.

The accumulation unit 13C receives, from the server 3C, a sending result of a promotion to the user i. Moreover, the accumulation unit 13C accumulates training data including the sending result which has been received and feature information of the user i in the storage unit 150B in association with the predictor s1 which has been used in determination of the user i.

(Detailed Configuration of Determination Unit)

The following description will discuss a detailed configuration of the determination unit 12C. The determination unit 12C includes a management unit 121C, a prediction unit 122C, a first determination unit 123C, a second determination unit 125C, and an advancement unit 124C.

The management unit 121C manages S pieces of predictors, as with the management unit 121B in the third example embodiment. Details of the S pieces of predictors are as described in the third example embodiment. Note, however, that details of a process which is carried out by the management unit 121C using the predictors is different from those in the third example embodiment.

Specifically, the management unit 121C sequentially uses the predictors in each of trials to carry out a prediction process. In a case where a determination condition is satisfied, the management unit 121C carries out an advancement process. In a case where the determination condition is not satisfied, the management unit 121C carries out a first determination process or a second determination process. In a case where the first determination process or the second determination process has been carried out using any of the predictors, the management unit 121B then does not carry out processes using the other predictors in that trial.

(Determination Condition)

The determination condition used by the management unit 121C is different from the determination condition used by the management unit 121B in the third example embodiment. In the present example embodiment, a condition in which “each of prediction errors is greater than a second threshold and is equal to or lower than a first threshold” is used as the determination condition. Specifically, the first threshold is expressed by expression (1) below. The second threshold is expressed by expression (2) below.

αc^{-s} (1)

α\sqrt{d/T} (2)

Where: T represents the total number of times of trials; s represents the order determined for the predictors, as described above; d represents a dimensionality of feature information of a user i in a trial t; and a and c are coefficients of 0 or more.

(Dimensionality of Feature Information)

Here, the determination condition is a condition based on the dimensionality of feature information. Specifically, a larger value is set for a in expressions (1) and (2) above as the dimensionality d of feature information increases. For example, a is expressed by the following expressions (3) and (4).

$$α = {β}_{T} ( δ / S ) \qquad ( 3 )$$

$$\\ \begin{matrix}{β}_{t} ( δ ) = R \sqrt{d log ( \frac{1 + ( t - 1 ) {L}^{2} / λ}{δ} )} + \sqrt{λ} M for all t ∈ [ T ] & \text{(4)}\end{matrix}$$

Where δ represents a probability of prediction. T represents the total number of times of trials, as described above. S represents the total number of predictors, as described above. L represents an upper bound of a norm of feature information. λ represents a non-negative tuning parameter. M represents complexity of a function representing a relation between feature information and observation. R represents an upper bound of a magnitude of noise applied to observation.

(Configuration of Prediction Unit)

The prediction unit 122C carries out the prediction process. The prediction process is a process of predicting, with use of a current predictor s, a prediction error involved in a prediction value of a sending result for each of users in a user group dealt with by the current predictor s. Specifically, the prediction process includes a learning process in which, in a trial t, the current predictor s is caused to learn a relation θ_{t,s} between an observation value of a sending result and feature information. The prediction process also includes a calculation process of calculating, in a trial t, a prediction value γ_{t,s}(i) and a prediction error w_{t,s}(i) of the sending result with use of the relation θ_{t,s}. The prediction function and the prediction error function which are used by the prediction unit 122C in the calculation process are expressed by the following expressions (5) and (6).

\hat{r}_{t,s}(i)←\hat{θ}ₜ^{T}xᵢ(i) (5)

w_{t,s}(i)←α\sqrt{xₜ(i)^{T}V_{t-1,s}⁻ⁱxₜ(i)} (6)

Where: xₜ(i) represents feature information of a user i in a trial t; θₜ is a coefficient that represents a linear relation learned by machine learning; and γ_{t,s}(i) is a prediction value of a sending result of a promotion to the user i, which has been predicted using a current predictor s in the trial t. Moreover, V_{t-1,s} is calculated in a process of learning by the predictor s using the training data Ψ_{t,s}.

(Configuration of First Determination Unit)

The first determination unit 123C carries out the first determination process. The first determination process in the present example embodiment is different from the first determination process in the third example embodiment. The first determination process according to the present example embodiment determines a user to be selected from among users in a user group I_{t,s} dealt with by the current predictor s in a case where the determination condition is not satisfied and the following expression (7) is satisfied.

w_{t,s}(i)>αc^{-s} for some i∈I_{t,s} (7)

In this manner, the first determination unit 123C determines, in a case where a prediction error predicted for at least any of the users i exceeds the first threshold, a user to be selected from among users in the user group I_{t,s} dealt with by the current predictor s. Specifically, the first determination unit 123C determines to select a user i for whom the prediction error has exceeded the first threshold.

(Configuration of Second Determination Unit)

The second determination unit 125C carries out the second determination process. The second determination process determines a user to be selected from among users in the user group I_{t,s} dealt with by the current predictor in a case where the determination condition is not satisfied and the following expression (8) is satisfied.

w_{t,s}(i)≤α\sqrt{d/T} for all i∈I_{t,s} (8)

In this manner, the first determination unit 123C determines, in a case where prediction errors predicted for all of the users i are equal to or lower than the second threshold, a user to be selected from among users in the user group I_{t,s} dealt with by the current predictor s. Specifically, the second determination unit 125C determines to select a user i for whom a sum of the prediction value and the prediction error is maximized.

(Configuration of Advancement Unit)

The advancement unit 124C carries out the advancement process. The advancement process is a process in which, in a case where a determination condition is satisfied, an option group I_{t,s+1} to be dealt with by a next predictor s+1 is extracted from an option group I_{t,s} dealt with by a current predictor, and the process is advanced to the next predictor s+1.

Here, an option group which is extracted by the advancement unit 124C is expressed by the following expression (9).

$${I}_{t , s + 1} ← \{ i ∈ {I}_{t , s} \vert {\hat{r}}_{t , s} ( i ) + {w}_{t , s} ( i ) \geq {max}_{{i}^{′} ∈ {I}_{t , s}} ( {\hat{r}}_{t , s} ( {i}^{′} ) + {w}_{t , s} ( {i}^{′} ) ) - 5 {αc}^{- s} \} \qquad ( 9 )$$

In this manner, the advancement unit 124C extracts, from among the user group I_{t,s} which is dealt with by the current predictor s, a user for whom a sum of the prediction value and the prediction error is greater than a third threshold. Here, the third threshold is a value obtained by subtracting Sac-s from a maximum value of the sum of the prediction value and the prediction error, as indicated in expression (9). Accordingly, the user group I_{t,s}+1 to be dealt with by the next predictor s+1 is a user group which is more likely to be an optimal option among the user group I_{t,s} dealt with by the current predictor s.

In this manner, in a case where prediction errors which are predicted by the current predictor s are greater than the second threshold and equal to or lower than the first threshold, the advancement unit 124C narrows down the user group I_{t,s} of interest with reference to the prediction result by the current predictor s, and advances the process to the next predictor s+1.

<Flow of Information Processing Method>

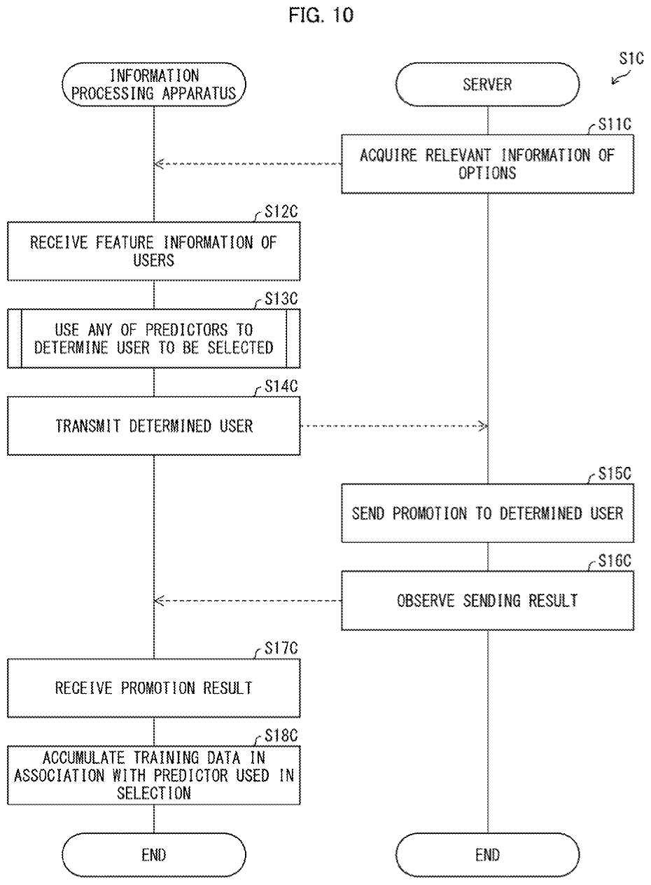

The following description will discuss a flow of an information processing method S1C that is carried out by the information processing system 10C configured as described above, with reference to FIG. 10. FIG. 10 is a flowchart illustrating the flow of the information processing method S1C. The information processing system 10C carries out the information processing method S1C in each of trials of determining a user to be selected from among the plurality of users i.

As illustrated in FIG. 10, the information processing method S1C includes steps S11C through S18C.

(Step S11C)

In step S11C, the acquisition unit 31C of the server 3C acquires pieces of feature information of the respective plurality of users. Moreover, the acquisition unit 31C transmits the acquired pieces of feature information to the information processing apparatus 1C.

(Step S12C)

In step S12C, the acquisition unit 11C of the information processing apparatus 1C receives pieces of feature information of the respective users from the server 3C.

(Step S13C)

In step S13C, the determination unit 12C determines a user to be selected from among the plurality of users. Details of the determination process will be described later.

(Step S14C)

In step S14C, the determination unit 12C transmits information indicating the determined user to the server 3C.

(Step S15C)

In step S15C, the selection unit 32C of the server 3C sends a promotion to the user who is indicated by information received from the information processing apparatus 1C.

(Step S16C)

In step S16C, the observation unit 33C observes a purchasing behavior of the user to whom the promotion has been sent by the selection unit 32C, and transmits the observed sending result to the information processing apparatus 1C.

(Step S17C)

In step S17C, the accumulation unit 13C of the information processing apparatus 1C accumulates the sending result which has been received and feature information of the user who has been determined in step S13C, as training data, in the storage unit 150C.

<Detailed Flow of Determination Process>

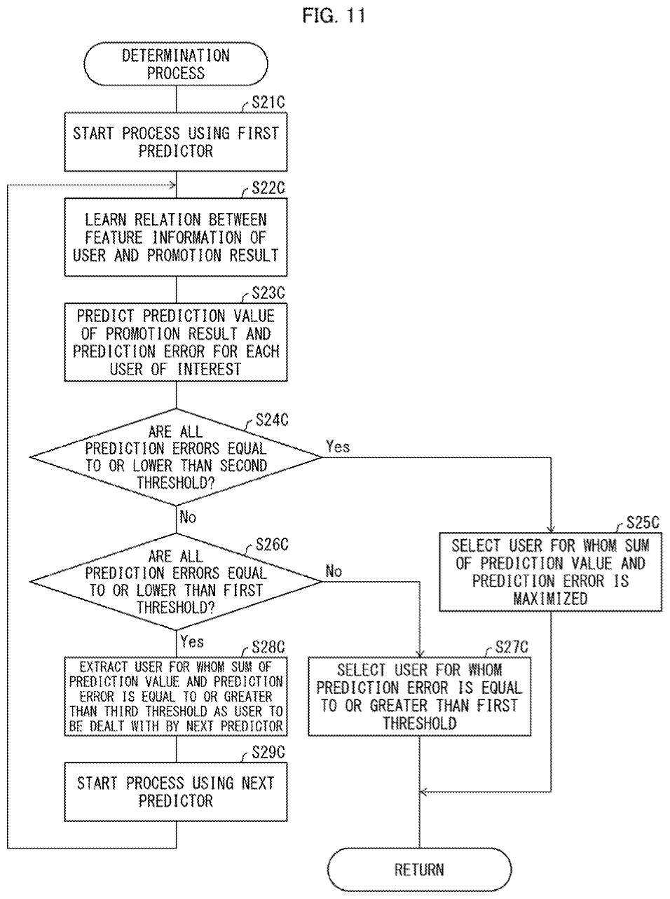

Next, the following description will discuss a detailed flow of the process in step S13C with reference to FIG. 11. FIG. 11 is a flowchart illustrating in detail a flow of a process of determining a user to be selected. As illustrated in FIG. 11, step S13C includes steps S21C through S29C.

(Step S21C)

In step S21C, the management unit 121C starts a process using a first predictor.

(Step S22C)

In step S22C, the prediction unit 122C causes a current predictor to learn a relation between a sending result and feature information. Specifically, the prediction unit 122C constructs a prediction function and a prediction error function using the current predictor.

(Step S23C)

In step S23C, the prediction unit 122C predicts, with use of the current predictor, a prediction error which is involved in a prediction value of a sending result for each of users in a user group which is dealt with by the current predictor. Specifically, the prediction unit 122C calculates a prediction value and a prediction error by applying feature information of each of the users to the prediction function and the prediction error function constructed in step S22C.

(Step S24C)

In step S24C, the management unit 121C determines whether or not each of the prediction errors predicted in step S23C is equal to or lower than the second threshold.

(Yes in Step S24C: Step S25C)

If it is determined to be Yes in step S24C, the second determination unit 125C determines, in step S25C, to select a user for whom a sum of the prediction value and the prediction error predicted in step S23C is maximized. Then, the second determination unit 125C transmits information indicating the determined user to the server 3C, and ends the determination process.

(No in Step S24C: Step S26C)

Meanwhile, if it is determined to be No in step S24C, the management unit 121C determines, in step S26C, whether or not the prediction errors predicted in step S23C are equal to or lower than the first threshold.

(No in Step S26C: Step S27C)

If it is determined to be No in step S26C, the first determination unit 123C determines, in step S27C, to select a user for whom the prediction error predicted in step S23C exceeds the first threshold. Then, the first determination unit 123C transmits information indicating the determined user to the server 3C, and ends the determination process.

(Yes in Step S26C: Step S28C)

If it is determined to be Yes in step S26C, in step S28C, the advancement unit 124C extracts, from the option group dealt with by the current predictor, one or more options as an option group to be dealt with by the next predictor.

(Step S29C)

In step S29C, the management unit 121C starts a process using the next predictor and repeats the process from step S22C.

### EXAMPLES

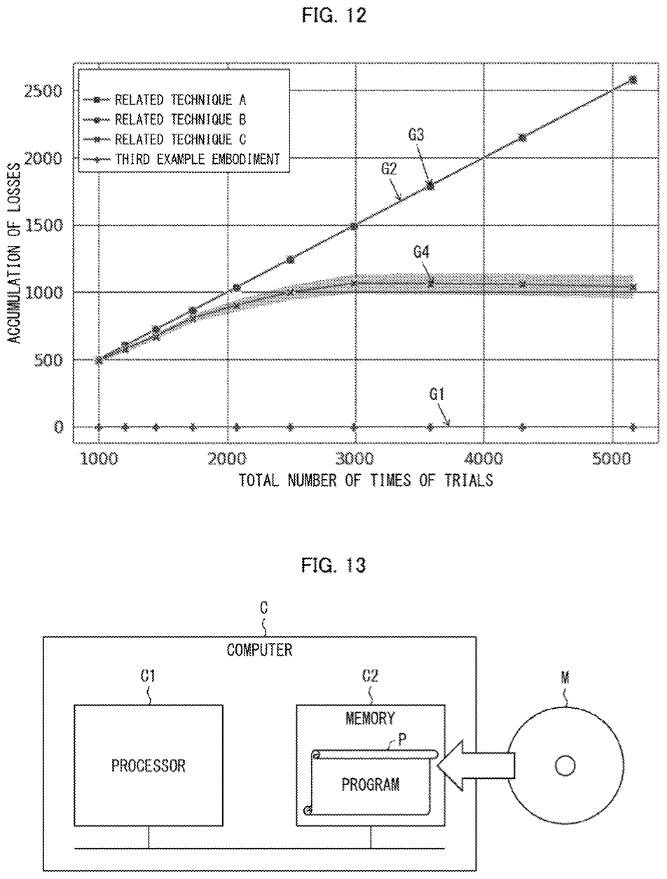

Next, the following description will discuss an example in which a simulation has been carried out using the information processing apparatus 1C according to the present example embodiment, with reference to FIG. 12. FIG. 12 is a graph illustrating simulation results.

In FIG. 12, the horizontal axis represents the total number of times of trials T, and the vertical axis represents accumulation of losses. Example G1 indicates a simulation result which has been carried out using the information processing apparatus 1C. Comparative Examples G2 through G4 are simulation results which have been carried out using related techniques A through C for comparison. Here, the related techniques A, B, and C used Greedy, LinUCB, and LinTS, which are known as publicly known bandit algorithms.

The simulations in Example G1 and Comparative Examples G2 through G4 were carried out under the following conditions. That is, the number of users was 2. That is, i was 1 or 2. Moreover, feature information xₜ(i) and an observation value γₜ(i) of the user to be acquired were changed as follows in the first half and the second half of the total number of times of trials T. That is, in this Example, a relation between the feature information xₜ(i) and the observation value γₜ(i) of the user differs greatly between the first half and the second half, and the relation cannot be expressed by a single linear model.

(First half: t<T/2)

xₜ(1)=(ε,0), xₜ(2)=(ε,0)

γₜ(1)=−ε/2, γt(2)=−ε/2
Where 0<ε<<1
(Second half: t≥T/2)

xₜ(1)=(2,1), xt(2)=(0,0)

γₜ(1)=1/2, γt(2)=0

As a result, as illustrated in FIG. 12, in Example G1 using the information processing apparatus 1C, accumulated losses were 0, regardless of the total number of times of trials T. In contrast, in Comparative Examples G2 through G4 using the related techniques A through C, accumulated losses increased as the total number of times of trials T increased.

As described above, in this Example G1, a result was obtained in which accumulated losses like those occurred in Comparative Examples G2 through G4 did not occur when the information processing apparatus 1C according to the present example embodiment was used.

<Effect of the Present Example Embodiment>

In the present example embodiment, it is possible to further increase accumulation of observation values (sending results), in addition to effects similar to those of the second and third example embodiments. This is because a condition corresponding to the dimensionality of feature information of the user is used as the determination condition for determining whether or not to advance the process from each of the predictors to the next predictor. It is therefore possible to more sufficiently absorb a difference of the linear model from an original relation between feature information of the user and an observation value.

[Variation]

In each of the foregoing example embodiments, the number of predictors which are initially generated can be one. For example, each of the information processing apparatuses generates a new predictor in a case where the information processing apparatus determines that a predictor(s) which has already been generated in each of trials is not suitable for determining an option. For example, in the third and fourth example embodiments, in a case where all of one or more predictors that have already been generated satisfy the determination condition, the determination unit generates a new predictor and causes the new predictor to proceed with a process.

[Software Implementation Example]

The functions of part of or all of the information processing apparatuses 1, 1A, 1B, and 1C can be realized by hardware such as an integrated circuit (IC chip) or can be alternatively realized by software.

In the latter case, each of the information processing apparatuses 1, 1A, 1B, and 1C is realized by, for example, a computer that executes instructions of a program that is software realizing the foregoing functions. FIG. 13 illustrates an example of such a computer (hereinafter, referred to as “computer C”). The computer C includes at least one processor C1 and at least one memory C2. The memory C2 stores a program P for causing the computer C to function as the information processing apparatuses 1, 1A, 1B, and 1C. In the computer C, the processor C1 reads the program P from the memory C2 and executes the program P, so that the functions of the information processing apparatuses 1, 1A, 1B, and 1C are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other devices. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some of or all of the foregoing example embodiments can also be described as below. Note, however, that the present invention is not limited to the following supplementary notes.

(Supplementary Note 1)

An information processing apparatus, including: an acquisition means that acquires pieces of relevant information which are respectively associated with a plurality of options; a determination means that determines an option to be selected from among the plurality of options; and an accumulation means that accumulates, as training data, an observation value of a gain which has been obtained when the option determined by the determination means had been selected and relevant information of the option in a storage apparatus, the determination means determining, with use of any of a plurality of predictors, an option to be selected from among the plurality of options, and the plurality of predictors independently learning a relation between the relevant information and the observation value with reference to the training data.

According to the configuration of supplementary note 1, any of the plurality of predictors is used to determine an option to be selected from among the plurality of options. Moreover, the plurality of predictors learn the relation between relevant information and an observation value independently of each other with reference to training data. Therefore, it is possible to use, in order to determine an option to be selected from among a plurality of options, a predictor which has learned a relation between an observation value and relevant information more appropriately. As a result, the present example embodiment makes it possible to determine an option that leads to a further increase in gain of accumulation.

(Supplementary Note 2)

The information processing apparatus according to supplementary note 1, in which: (i) the determination means predicts, with use of any of the plurality of predictors, a prediction error for each of one or more options included in an option group to be dealt with by the predictor, the prediction error being involved in a prediction value of the gain; (ii) in a case where a determination condition pertaining to prediction errors is not satisfied, the determination means determines an option to be selected from among options in an option group dealt with by the predictor; and (iii) in a case where the determination condition is satisfied, the determination means extracts one or more options from the option group dealt with by the predictor, and predicts, with use of another predictor, a prediction error of each of the one or more options which have been extracted as an option group to be dealt with by the another predictor.

According to the configuration of supplementary note 2, it is possible to use, as the determination condition, a condition that determines whether or not to predict a relation between an observation value and relevant information with accuracy that is equal to or higher than a certain criterion. With this configuration, it is possible to determine, with use of another predictor that should be caused to learn more, an option to be selected, while narrowing down options with use of a predictor which has learned with higher accuracy. As a result, an option that further increases accumulation of observation values can be selected even in a case where a relation between an observation value and relevant information cannot be accurately predicted by a single predictor.

(Supplementary Note 3)

The information processing apparatus according to supplementary note 2, in which the determination means uses, as the determination condition, a condition that includes a condition in which each of prediction errors is equal to or lower than a threshold.

According to the configuration of supplementary note 3, it is possible to determine an option to be selected using a predictor that needs to learn more because the predictor is greater than the threshold, after narrowing down options using a predictor having a smaller prediction error. As a result, even in a case where a relation between an observation value and relevant information cannot be accurately learned by a single predictor, it is possible to select an option that is optimal for learning from among options with smaller prediction errors.

(Supplementary Note 4)

The information processing apparatus according to supplementary note 2 or 3, in which the determination means uses, as the determination condition, a condition based on dimensionality of the relevant information.

According to the configuration of supplementary note 4, it is possible to more accurately absorb a deviation of an original relation between an observation value and relevant information from a relation which is learned by each of the predictors.

(Supplementary Note 5)

The information processing apparatus according to any one of supplementary notes 1 through 4, in which: the accumulation means accumulates the training data in the storage apparatus while associating a piece of training data with a predictor which has been used in determination of an option by the determination means; and each of the plurality of predictors learns the relation with reference to a piece of training data associated with that predictor from among the training data accumulated in the storage apparatus.

According to the configuration of supplementary note 5, it is possible to cause a predictor used in determination of an option to learn more so that an observation value can be predicted more accurately.

(Supplementary Note 6)

The information processing apparatus according to any one of supplementary notes 1 through 5, in which each of the plurality of predictors learns a linear relation as the relation.

According to the configuration of supplementary note 6, it is possible to use a predictor which has learned linearity that is more appropriate as a relation between an observation value and relevant information in order to determine an option to be selected from among the plurality of options.

(Supplementary Note 7)

An information processing method, including: acquiring, by an information processing apparatus, pieces of relevant information which are respectively associated with a plurality of options; determining, by the information processing apparatus, an option to be selected from among the plurality of options; and accumulating, by the information processing apparatus, an observation value of a gain which has been obtained when the option determined had been selected and relevant information of the option in a storage apparatus as training data, in order to determine an option to be selected from among the plurality of options, any of a plurality of predictors being used, and the plurality of predictors independently learning a relation between the relevant information and the observation value with reference to the training data.

According to the configuration of supplementary note 7, it is possible to bring about an effect similar to that of the information processing apparatus according to supplementary note 1.

(Supplementary Note 8)

A storage medium storing a program that causes a computer to function as an information processing apparatus, the program causing the computer to function as: an acquisition means that acquires pieces of relevant information which are respectively associated with a plurality of options; a determination means that determines an option to be selected from among the plurality of options; and an accumulation means that accumulates, as training data, an observation value of a gain which has been obtained when the option determined by the determination means had been selected and relevant information of the option in a storage apparatus, the determination means determining, with use of any of a plurality of predictors, an option to be selected from among the plurality of options, and the plurality of predictors independently learning a relation between the relevant information and the observation value with reference to the training data.

According to the configuration of supplementary note 8, it is possible to bring about an effect similar to that of the information processing apparatus according to supplementary note 1.

(Supplementary Note 9)

An information processing system including an information processing apparatus and a server, the information processing apparatus including: an acquisition means that receives, from the server, pieces of relevant information which are respectively associated with a plurality of options; a determination means that determines an option to be selected from among the plurality of options and that transmits, to the server, information indicating the option which has been determined; and an accumulation means that receives, from the server, an observation value of a gain which has been obtained when the option determined by the determination means had been selected, and that accumulates, as training data, the observation value which has been received and relevant information of the option in a storage apparatus, the determination means determining, with use of any of a plurality of predictors, an option to be selected from among the plurality of options, and the plurality of predictors independently learning a relation between the relevant information and the observation value with reference to the training data, the server including: an acquisition means that acquires the relevant information and transmits the relevant information to the information processing apparatus; a selection means that selects an option which is indicated by information received from the information processing apparatus; and an observation means that observes a gain which is obtained by selection by the selection means, and that transmits an observation value which has been observed to the information processing apparatus.

According to the configuration of supplementary note 9, it is possible to bring about an effect similar to that of the information processing apparatus according to supplementary note 1.

(Supplementary Note 10)

An information processing method, including: receiving, by an information processing apparatus, pieces of relevant information which are respectively associated with a plurality of options from a server; determining, by the information processing apparatus, an option to be selected from among the plurality of options and transmitting, by the information processing apparatus, information indicating the option which has been determined to the server; and receiving, by the information processing apparatus, an observation value of a gain which has been obtained when the option determined had been selected from the server, and accumulating, by the information processing apparatus, the observation value which has been received and relevant information of the option in a storage apparatus as training data, in order to determine an option to be selected from among the plurality of options, any of a plurality of predictors being used, and the plurality of predictors independently learning a relation between the relevant information and the observation value with reference to the training data, the information processing method further including: acquiring, by the server, the relevant information and transmitting, by the server, the relevant information to the information processing apparatus; selecting, by the server, an option which is indicated by information received from the information processing apparatus; and observing, by the server, a gain which is obtained by selection of the option, and transmitting, by the server, an observation value which has been observed to the information processing apparatus.

According to the configuration of supplementary note 10, it is possible to bring about an effect similar to that of the information processing apparatus according to supplementary note 1.

[Additional Remark 3]

Furthermore, some of or all of the foregoing example embodiments can also be expressed as below.

An information processing apparatus, including at least one processor, the at least one processor carrying out: an acquisition process of acquiring pieces of relevant information which are respectively associated with a plurality of options; a determination process of determining an option to be selected from among the plurality of options; and an accumulation process of accumulating, as training data, an observation value of a gain which has been obtained when the option determined in the determination process had been selected and relevant information of the option in a storage apparatus, in the determination process, an option to be selected from among the plurality of options being determined with use of any of a plurality of predictors, and the plurality of predictors independently learning a relation between the relevant information and the observation value with reference to the training data.

Note that the information processing apparatus can further include a memory. The memory can store a program for causing the processor to carry out the acquisition process, the determination process, and the accumulation process. The program can be stored in a computer-readable non-transitory tangible storage medium.

### REFERENCE SIGNS LIST

1, 1A, 1B, 1C: Information processing apparatus
10A, 10C: Information processing system
11, 11A, 11B, 11C: Acquisition unit
12, 12A, 12B, 12C: Determination unit
13, 13A, 13B, 13C: Accumulation unit
1101B, 110C: Control unit
121B, 121C: Management unit
122B, 122C: Prediction unit
123B, 123C: First determination unit
124B, 124C: Advancement unit
125C: Second determination unit
150B, 150C: Storage unit
160C: Communication unit
3, 3A, 3C: Server
31A, 31C: Acquisition unit
32A, 32C: Selection unit
33A, 33C: Observation unit
34C: Communication unit

What is claimed is:

1. An information processing apparatus, comprising at least one processor, the at least one processor carrying out:
an acquisition process of acquiring pieces of relevant information which are respectively associated with a plurality of options;
a determination process of determining an option to be selected from among the plurality of options; and
an accumulation process of accumulating, as training data, an observation value of a gain which has been obtained when the option determined in the determination process had been selected and relevant information of the option in a storage apparatus,
in the determination process, an option to be selected from among the plurality of options being determined with use of any of a plurality of predictors, and the plurality of predictors independently learning a relation between the relevant information and the observation value with reference to the training data.

2. The information processing apparatus according to claim 1, wherein:
in the determination process,
(i) a prediction error is predicted with use of any of the plurality of predictors for each of one or more options included in an option group to be dealt with by the predictor, the prediction error being involved in a prediction value of the gain;
(ii) in a case where a determination condition pertaining to prediction errors is not satisfied, an option to be selected from among options in an option group dealt with by the predictor is determined; and
(iii) in a case where the determination condition is satisfied, one or more options are extracted from the option group dealt with by the predictor, and a prediction error of each of the one or more options which have been extracted is predicted, with use of another predictor, as an option group to be dealt with by the another predictor.

3. The information processing apparatus according to claim 2, wherein:
in the determination process, a condition that includes a condition in which each of prediction errors is equal to or lower than a threshold is used as the determination condition.

4. The information processing apparatus according to claim 2, wherein:
in the determination process, a condition based on dimensionality of the relevant information is used as the determination condition.

5. The information processing apparatus according to claim 1, wherein:
in the accumulation process, the training data is accumulated in the storage apparatus while a piece of training data is associated with a predictor which has been used in determination of an option in the determination process; and
each of the plurality of predictors learns the relation with reference to a piece of training data associated with that predictor from among the training data accumulated in the storage apparatus.

6. The information processing apparatus according to claim 1, wherein each of the plurality of predictors learns a linear relation as the relation.

7. An information processing method, comprising:
acquiring, by an information processing apparatus, pieces of relevant information which are respectively associated with a plurality of options;
determining, by the information processing apparatus, an option to be selected from among the plurality of options; and
accumulating, by the information processing apparatus, an observation value of a gain which has been obtained when the option determined had been selected and relevant information of the option in a storage apparatus as training data,
in order to determine an option to be selected from among the plurality of options, any of a plurality of predictors being used, and the plurality of predictors independently learning a relation between the relevant information and the observation value with reference to the training data.

8. A non-transitory storage medium storing a program that is to be executed by a computer, the program causing the computer to carry out:
an acquisition process of acquiring pieces of relevant information which are respectively associated with a plurality of options;
a determination process of determining an option to be selected from among the plurality of options; and
an accumulation process of accumulating, as training data, an observation value of a gain which has been obtained when the option determined in the determination process had been selected and relevant information of the option in a storage apparatus,
in the determination process, an option to be selected from among the plurality of options being determined with use of any of a plurality of predictors, and the plurality of predictors independently learning a relation between the relevant information and the observation value with reference to the training data.

9. An information processing system comprising an information processing apparatus recited in claim 1 and a server,
the server carrying out:
an acquisition process of acquiring the relevant information and transmitting the relevant information to the information processing apparatus;
a selection process of selecting an option which is indicated by information received from the information processing apparatus; and
an observation process of observing a gain which is obtained by selection in the selection process, and transmitting an observation value which has been observed to the information processing apparatus.

10. (canceled)
